(19) United States
(12) Patent Application Publication
(10) Pub. No.: US 2005/0112164 A1
(43) Pub. Date: May 26, 2005

(54) Insect repellent composition containing essential oils

(76) Inventor: Alison Lewey, Corinna, ME (US)

Correspondence Address: ANTHONY D. PELLEGRINI RUDMAN & WINCHELL, LLC, 84 HARLOW STREET, P.O. BOX 1401, BANGOR, ME, 04402-1401, US

(21) Appl. No.: 10/719,851

(22) Filed: Nov. 24, 2003

(51) Int. Cl. A01N 65/00; A01N 25/00

(52) U.S. Cl. 424/405; 424/745; 424/747; 424/778

(57) ABSTRACT

An insect repellent comprised of all-natural ingredients to be applied directly to human skin, articles of clothing, and pets. The repellent action is attributable to a blend of essential oils of lemongrass, peppermint, thyme, geranium, and rosemary. The essential oils are blended into a carrier comprised of soybean oil and wheat germ oil. The resulting blend is effective against flying insects and arthropods, is non-toxic and safe for use on children, and is environmentally safe.

### BACKGROUND OF THE INVENTION

1. Field of the Invention

The invention relates generally to insect repellents, and more particularly to all-natural insect repellents having a high degree of efficacy in repelling insects, arthropods, and other biting pests without resorting to the use of chemical additives in general or DEET (N,N-diethyl-m-toluamide) in particular.

2. Description of the Prior Art

Insects and other biting pests, such as arthropods (referred to collectively in this application simply as “insects”), are both a nuisance and potentially a health danger. Not only are the bites caused by these creatures painful and the resulting itch annoying, but medical science now knows that many diseases may be caused by biting insects. Malaria, for example, is communicated by mosquitoes and is responsible for millions of deaths each year. In North American, a recent outbreak of West Nile virus, also carried by mosquitoes, has resulted in hundreds of deaths. Other diseases, such as Lyme disease, transmitted by ticks, can cause serious illness.

Traditionally, insect repellents designed to be applied directly on humans (as opposed to area repellents, such as room foggers or candles) have been formulated using chemicals. The active ingredients in most insect repellents currently on the market today include DEET, which has been shown to be an effective repellent against biting insects. However, DEET itself is known to present health risks and is a potential carcinogen. High levels of DEET are particularly dangerous for children. For that reason, adults are encouraged not to use maximum strength DEET products, and far weaker formulations of DEET are recommended for use on children. However, these weaker formulations are not as effective as more potent formulations of DEET, thereby forcing the user to choose between effectiveness and personal safety.

There has therefore been a great demand for alternatives to DEET-based insect repellents which are safe yet also effective. Insect repellents based on natural ingredients, such as essential oils, are potential substitutes.

Various formulations disclosed in the prior art make use of compositions of essential oils as insect repellents, though most also use chemical and other non-natural additives, as well as DEET. For example, Uick, International Publication No. WO 97/49380, published Dec. 13, 1997, discloses an insect repellent comprising one or more essential oils and/or DEET, blended with sunscreens. While one embodiment of this invention may employ four of the five essential oils of the present invention, Uick also requires chemical additives not found in the present invention. Likewise, Watkins, et al., U.S. Pat. No. 6,451,844, issued on Sep. 17, 2002, discloses the use of a multitude of repellent substances, including essential oils, used in conjunction with various chemical compositions; Garrison, et al., U.S. Patent No. 6,355,264, issued on Mar. 12, 2002, discloses the use of one essential oil as an insect repellent, but also requires chemical additives and an alcohol-based carrier; and Beldock, et al., U.S. Pat. Nos. 5,227,406, 5,346,922, and 5,621,013, all disclose insect repellents containing trace amounts of essential oils, though they also include chemicals and other additives.

The prior art discloses various insect repellents which may be formulated using only essential oils as the repellent ingredient, but the essential oils contemplated do not include all of the essential oils used in the present invention. Moreover, these inventions have preferred embodiments which use chemicals and other additives, and use non-natural carriers. Examples of these are Partelow, U.S. Pat. No. 6,300,324, issued Oct. 9, 2001 (discloses use of two of the five essential oils of the present invention); Blum et al., U.S. Pat. No. 5,885,600, issued Mar. 23, 1999 (discloses use of up to 11 specific essential oils as insect repellents, including two of the essential oils used in the present invention); and Radwan, et al., U.S. Pat. No. 5,688,509, issued on Nov. 18, 1997 (discloses an insect repellent in which the active ingredient may be comprised solely of essential oils, to be impregnated into a controlled release medium, and including one of the five essential oils of the present invention).

Khazan, U.S. Patent Application No. 20020034556, published Mar. 21, 2002, discloses a formulation to be used as an insect repellent which may include three of the five essential oils of the most preferred embodiment of the present invention. However, it also calls for the use of citronella oil, D-limonene, and 2 or more synergists, such as aldehyde C-14 and aldehyde C-18. The use of the chemical additives distinguish Khazan from the present invention. While Khazan, unlike Radwan, discloses an insect repellent for direct application on humans, it uses chemicals and other non-natural ingredients and thus fails to accomplish the objectives of the present invention.

Fried, et al., International Publication No. WO 02/098439, published Dec. 12, 2002, is nearly identical to Khazan (Khazan is one of the named inventors in Fried, et al.), differing only in that it discloses two additional essential oils, both of which are found in the present invention, and discloses the use of soybean oil as a carrier, but considers same to be suboptimal. In all other respects, Fried, et al. suffers from the same deficiencies as' Khazan with regard to the present invention.

Thielen, et al., U.S. Pat. No. 4,671,960, issued on Jun. 9, 1987, discloses the use of herbs as an insect repellent, without the use of chemical additives. This invention employs dry, finely chopped solids of various herbs, with the acceptable addition of essential oils. This combination is intended to be used on pet collars. The herbs disclosed include dried chamomile, pennyroyal, and eucalyptus, and the essential oils include pennyroyal oil, eucalyptus oil, and citronella oil. While this discloses an all-natural repellent, it is not intended for topical application to human skin, nor is it primarily liquid-based, but rather a composition to be applied to fabric. Moreover, the herbs and essential oils disclosed differ from those used in the present invention. Thielen, et al. does not meet the need of an all-natural insect repellent which is directly applied to humans.

Sherwood, et al., U.S. Pat. No. 5,106,622, issued on Apr. 21, 1992, is perhaps closest in spirit to the present invention. It discloses a formulation to be used as an insect repellent which includes only natural active and inactive ingredients, including four essential oils as active ingredients and a natural oil-based carrier. However, none of the four essential oils are the same as the essential oils of the present invention, nor is the carrier comprised of the same natural oils. Given that there are scores of essential oils, each with different properties and characteristics, the selection of specific essential oils to combine into a formulation is critical to creating an effective repellent. Sherwood, et al. therefore does not anticipate the present invention.

### SUMMARY OF THE INVENTION

It is an object of this invention to provide an all-natural, chemical-free insect repellent which is effective in repelling insects while avoiding the potentially harmful effects of chemical-based insect repellents, especially for children.

It is another object of this invention to provide an effective insect repellent which does not use DEET (N,N-diethyl-m-toluamide).

It is a further object of this invention to provide an effective insect repellent comprised of ingredients which may be obtained from small producers, such as family farmers.

It is a further object of this invention to provide an effective insect repellent based on traditional Native American knowledge and herbal lore.

It is a further object of this invention to provide an effective insect repellent which has a pleasing aroma and is pleasant to use.

These and other objects of the invention are obtained by utilizing as the active ingredients of the insect repellent only essential oils, and by utilizing as the inactive ingredients only natural organic oils. The essential oils are selected based on their inherent individual repellent properties and, in the preferred embodiment, on their synergistic effect in combination with each other to increase their repellent properties. The inactive ingredients are selected on the basis of their ability to blend well with essential oils without adverse reaction while at the same time providing a pleasant medium for application onto human skin.

### DETAILED DESCRIPTION OF THE INVENTION

This invention is a liquid insect repellent intended to be applied directly to human skin, though it may also be applied to articles of clothing and to the skin or fur of animals. Its primary mode of operation is to create an aroma which is repellent to biting insects. While conceived primarily as a repellent to mosquitoes, the invention is also effective in repelling ticks, fleas, black flies, horseflies, ants, chiggers, bees, wasps, hornets, midges, and other biting insects and arthropods. The invention is not, however, an insecticide. Because it is non-lethal, it is extremely safe for humans, both adults and children, as well as pets. And because it is comprised of natural ingredients, the invention is non-toxic to the environment.

This invention utilizes one or more active ingredients comprised of organic agents and one or more inactive ingredients comprised of organic agents, in blended composition, to provide an effective insect repellent. The use of only natural organic ingredients distinguishes the invention from commercially available insect repellents. Even those which claim to contain natural active ingredients also contain synthetic or chemical-based components, either in the active ingredients or in the carrier.

In the preferred embodiments of the invention, the active ingredients are essential oils. Essential oils are the class of volatile oils obtained from plants and herbs possessing the odor and other characteristic properties of the plant. Essential oils have long been used in traditional Native American applications, medicinal and otherwise. This invention was developed by use of Native American herbal lore to select the best combinations of essential oils to effectively repel insects.

An important characteristic of essential oils is that they may be extracted from locally grown organic matter through simple processes, such as the cold pressing of plants and herbs. This eliminates the necessity of industrial processing of the ingredients, and allows the invention to be practiced at a local, personal level, e.g., involving family farmers as suppliers.

In the preferred embodiment of the invention, five essential oils are used. By using a combination of essential oils, the invention allows the essential oils to interact synergistically with each other to produce a cumulative repellent effect which exceeds the effects of the use of any single essential oil. It has been discovered that the following essential oils in combination produce a highly effective insect repellent: lemongrass oil, peppermint oil, thyme oil, geranium oil, and rosemary oil.

In addition to their effectiveness as an insect repellent, these five essential oils in combination produce an herbal aroma pleasant to humans. This provides a significant advantage over the prior art, in which insect repellents generally have an aroma unpleasant to humans. By having a pleasant aroma the invention encourages its use, both in initial application and in reapplication over time as needed. Insect repellents with an unpleasant aroma tend not to be used as often as necessary, thereby increasing the risk of insect bites.

The invention contains inactive ingredients which make up the majority of the composition by weight. In the preferred embodiments the inactive ingredients include one or both of the following: soybean oil and wheat germ oil. Both soybean oil and wheat germ oil mix well with essential oils. They also have the properties of being beneficial to the human skin, gliding on smoothly and absorbing quickly, thereby avoiding any lingering greasy feeling while at the same time moisturizing and conditioning the skin. Wheat germ oil also contains vitamin E, a natural substance having beneficial properties to human skin. In the most preferred embodiment both soybean oil and wheat germ oil are used in combination as the inactive ingredient.

Due to the high degree of effectiveness of the essential oils as an insect repellent, this invention requires relatively less active ingredient in comparison to the amount of inactive ingredient. Preferably, the active ingredients in the aggregate comprise between 5% and 20% of the composition by weight. In the most preferred embodiment, the active ingredients in the aggregate comprise 10% of the composition by weight. In addition, the individual essential oils work best when they are used in specific proportions relative to each other and to the total weight of the composition. Preferably, there should be relatively more lemongrass oil by weight than peppermint oil or thyme oil, and relatively less geranium oil and rosemary oil by weight than the other oils. The relative amounts by weight of peppermint oil and thyme oil should be substantially the same, and the relative amounts by weight of geranium oil and rosemary oil should be substantially the same. With regard to the inactive ingredients, there should be substantially more soybean oil by weight than wheat germ oil when both are used.

The preferred embodiments of the invention contain the following amounts of essential oils and inactive ingredients:
between 1½% and 6% by weight lemongrass oil;
between 1% and 4% by weight peppermint oil;
between 1% and 4% by weight thyme oil;
between ¾% and 3% by weight geranium oil;
between ¾% and 3% by weight rosemary oil;
between 60% and 94% by weight soybean oil; and
between 1% and 20% by weight wheat germ oil.

The most preferred embodiment of the invention contains the following amounts of essential oils and inactive ingredients:
3% by weight lemongrass oil;
2% by weight peppermint oil;
2% by weight thyme oil;
1½% by weight geranium oil;
1½% by weight rosemary oil;
80% by weight soybean oil; and
10% by weight wheat germ oil.

The separate ingredients comprising the invention are blended into the final composition by simply mixing them together. While no particular order of adding the individual ingredients to the composition is required, the preferred method comprises a first step of adding the inactive ingredient into the holding container of a mixing device, and if there are two or more inactive ingredients blending same together using the mixing device, followed by the steps of adding the active ingredients seriatim. As each active ingredient is added, it may be blended with the previously added ingredients, though this is not a requirement. The final step is to thoroughly blend all ingredients together using the mixing device once they have all been added to the holding container. Combining the ingredients as described into the resultant invention does not require any special environmental considerations, i.e., temperature and humidity need not be carefully controlled. The preferred method of formulation involves performing the foregoing steps at room temperature.

Following are five examples of testing performed on sample formulations of insect repellent. Two of the formulations were created in accordance with the present invention; one formulation was created in accordance with the specification disclosed in the prior art, with the intent of utilizing those aspects of the prior art closest to the present invention; and two of the formulations are commercially available products containing DEET.

### EXAMPLE 1

A formulation representing the preferred embodiment of the present invention was created using the following ingredients in the following amounts (percentages constitute proportion by weight of the total composition):
3% lemongrass oil;
2% peppermint oil;
2% thyme oil;
1.5% geranium oil;
1.5% rosemary oil;
80% soybean oil (inactive ingredient); and
10% wheat germ oil (inactive ingredient).

This composition was created by placing into an empty 1 liter stainless steel container 384 ml of soybean oil and 48 ml of wheat germ oil, and then stirring the ingredients for one minute using an electric handheld mixing device. Next, 14.4 ml of lemongrass oil, 9.6 ml of peppermint oil, 9.6 ml of thyme oil, 7.2 ml of geranium oil, and 7.2 ml of rosemary oil were added to the composition, one at a time, with the ingredients stirred for one minute as above after the addition of each subsequent ingredient.

This formulation was tested on human subjects using southern house mosquitoes, Culex quinquefasciatus. Experimentation was conducted using multiple plexiglass mosquito cages, each stocked with ten, 5-6 day-old colony-reared female mosquitoes. The cages were equipped with sliding doors to expose the mosquitoes to the skin of the test subjects.

A human subject prepared a portion of his skin with the formulation and placed a mosquito cage, sliding door down, directly over the treated area. The sliding door was then removed, such that the mosquitoes were exposed to that portion of the subject's skin having been treated with the formulation. The mosquitoes were exposed to the skin in this manner for two minutes, during such time the number of mosquito bites occurring was recorded. At the conclusion of two minutes the mosquitoes were removed from the subject. Simultaneously with this exposure of mosquitoes to the portion of the subject's skin having been treated with the formulation, another mosquito cage containing ten different mosquitoes was placed over a different portion of the subject's skin which had not been treated with any repellent formulation. This second group of mosquitoes was exposed to the untreated skin in the same way and for the same duration as described above. The number of mosquito bites incurred from this second exposure was recorded as a control.

This process was repeated four times, at one hour post-application of the formulation, two hours post-application, four hours post-application, and six hours post-application. Each time, fresh groups of mosquitoes were placed in the cages, and the cages were placed over the same portions of the subject's skin, i.e., over the same portion with the original application of the formulation and over the same control portion. There was no reapplication of the formulation between tests.

The above sequence of testing over the five time intervals was repeated three times for a test subject over the course of one day. The same test subject repeated these experiments in the same manner over a total of three different days. There were a total of three test subjects, each of which performed the experiments in the same manner. Thus, the preferred formulation was exposed to mosquitoes 135 times over the five different time intervals (27 times per time interval).

The result of the experiment was that the control experienced a total of 432 bites, for an average of 3.2 bites per test interval. The bites were spread over the five time intervals, from first application to 6 hours post-application, in ascending order, as follows: 104, 92, 64, 84, and 88 bites, for an average of 3.9, 3.4, 2.4, 3.1, and 3.3 bites per time interval, respectively. The preferred formulation experienced a total of 37 bites over all time intervals, for an average of 0.274 bites per time interval. These were spread over the five time intervals as follows: 1, 0, 2, 5, and 29 bites, for an average of 0.037, 0.000, 0.074, 0.185, and 1.074 bites per time interval.

The overall efficacy of the preferred formulation as compared to the control (no treatment) was 91.44% (calculated from the total average bites for the control minus the total average bites for the formulation divided by the total average bites for the control over all time intervals). On a per time interval basis, the efficacy of the preferred formulation was 99.05%, 100%, 96.92%, 94.03%, and 67.45%. The conclusion reached from the experiment is that the preferred formulation has a very high efficacy rate through four hours, but then the efficacy erodes substantially by the sixth hour post-application.

### EXAMPLE 2

An alternative formulation having one half the amount of active ingredients by weight as the preferred formulation was created using the following ingredients in the following amounts (percentages constitute proportion by weight of the total composition):
1½% lemongrass oil;
1% peppermint oil;
1% thyme oil;
¾% geranium oil;
¾% rosemary oil;
85% soybean oil (inactive ingredient); and
10% wheat germ oil (inactive ingredient).

This composition was created by placing into an empty 1 liter stainless steel container 408 ml of soybean oil and 48 ml of wheat germ oil, and then stirring the ingredients for one minute using an electric handheld mixing device. Next, 7.2 ml of lemongrass oil, 4.8 ml of peppermint oil, 4.8 ml of thyme oil, 3.6 ml of geranium oil, and 3.6 ml of rosemary oil were added to the composition, one at a time, with the ingredients stirred for one minute as above after the addition of each subsequent ingredient.

This alternative formulation was tested in the same manner and with the same number of exposures as the preferred formulation, as described in Example 1. The result of this experiment was that the alternative formulation experienced a total of 67 bites, for an average of 0.496 bites per time interval. These were spread over the five time intervals as follows: 1, 4, 5, 21, and 36 bites, for an average of 0.037, 0.148, 0.185, 0.778, and 1.333 bites per time interval.

The overall efficacy of the alternative formulation as compared to the control was 84.49%. On a per time interval basis, the efficacy of the alternative formulation was 99.05%, 95.65%, 92.29%, 74.90%, and 59.62%. The conclusion reached from this experiment is that the alternative formulation underperformed the preferred formulation at every time interval. It exhibited a high rate of efficacy through four hours with a substantial erosion by the sixth hour post-application. This is an expected result, since the alternative formulation contained only one half of the amount by weight of active ingredient as the preferred formulation.

### EXAMPLE 3

For comparison purposes, another formulation based on claims 3 and 5 of Fried, et al. was created using the following ingredients in the following amounts (percentages constitute proportion by weight of the total composition):
3% lemongrass oil;
2% peppermint oil;
2% thyme oil;
1.5% geranium oil;
1.5% rosemary oil;
3.3% citronella oil;
4.5% d-limonene (CAS No. 5989-27-5);
0.4% aldehyde C-14 (Dihydro-5-heptyl-2(3H)-furanone, CAS No. 104-67-6);
0.4% aldehyde C-18 (Dihydro-5-pentyl-2(3H)-furanone, CAS No. 57084-16-9); and
81.4% distilled water (inactive ingredient).

This composition was created by placing into an empty 1 liter stainless steel container 390.8 ml of distilled water. 16 ml of citronella oil was then added to the distilled water and the ingredients were stirred for one minute using an electric handheld mixing device. Next, 7.2 ml of geranium oil, 9.6 ml of peppermint oil, 14.4 ml of lemongrass oil, 9.6 ml of thyme oil, and 7.2 ml of rosemary oil were added to the composition, one at a time, with the ingredients stirred for one minute as above after the addition of each subsequent ingredient. 21.6 ml of d-limonene was then added to the composition and the ingredients stirred for one minute as above. Finally, 2 ml of aldehyde C-18 and 2 ml of aldehyde C-14 were added to the composition, one at a time, with the ingredients stirred for one minute as above after the addition of each.

The aldehydes are known synergists and the prior art suggests that the addition of these synergists will improve the efficacy of the essential oils. See Fried, et al. Citronella oil is another essential oil and d-limonene is known to have insect repelling characteristics. Id. The comparative formulation contained 18.6% by weight active ingredients. It is useful to compare the efficacy of the preferred embodiment of the invention with this comparative formulation which is based on a composition disclosed in the prior art, as the preferred formulation would appear to be disadvantaged in having substantially less active ingredient by weight, as well as no chemical additives.

The comparative formulation was tested in the same manner as the preferred formulation, as described in Example 1. The result of the experiment was that the comparative formulation experienced a total of 23 bites, for an average of 0.170 bites per time interval. These were spread over the five time intervals as follows: 3, 0, 0, 9, and 11 bites, for an average of 0.111, 0.000, 0.000, 0.333, and 0.407 bites per time interval.

The overall efficacy of the comparative formulation as compared to the control was 94.66%. On a per time interval basis, the efficacy of the comparative formulation was 97.15%, 100%, 100%, 89.26%, and 87.67%. The conclusion reached from this experiment is that the comparative formulation performed at substantially the same levels as the preferred formulation at every time interval up to four hours. This is a surprising result, since the comparative formulation contained nearly twice the amount by weight of active ingredient than the preferred formulation. However, the excess active ingredient contained in the comparative formulation consisted in large part of non-natural chemicals. Most tellingly, the two aldehyde synergists did not appear to improve the efficacy of the comparative formulation over the preferred formulation. The only advantage shown with the comparative formulation is that it appeared to retain a substantial degree of efficacy at six hours post-application, whereas the preferred formulation experienced a notable degradation in efficacy at that time interval. Nevertheless, when comparing the formulations over a four hour period, the preferred formulation is demonstrated to be efficacious and at least as good as, if not superior to, a formulation dependent in part on chemical additives.

### EXAMPLE 4

A commercial insect repellent (Cutter's RTM) containing 9.5% DEET was tested in the same manner as the preferred formulation, as described in Example 1. The result of the experiment was that the 9.5% DEET formulation experienced a total of 15 bites, for an average of 0.111 bites per time interval. These bites were spread over the five time intervals as follows: 0, 0, 0, 8, and 7 bites, respectively, for an average of 0.000, 0.000, 0.000, 0.296, and 0.259 bites per time interval.

The overall efficacy of this formulation as compared to the control was 96.53%. On a per time interval basis, the efficacy of the formulation was 100%, 100%, 100%, 90.45%, and 92.15%. The conclusion reached from the experiment is that the 9.5% DEET formulation performed at slightly better levels as compared to the preferred formulation during the first three time intervals, and underperformed at the four hour interval. This is a surprising result, since the 9.5% DEET formulation contained virtually the same amount by weight of active ingredient as the preferred formulation, and DEET has long been considered the only effective means for controlling mosquitoes. As with the formulation tested in Example 3, the only significant advantage shown with the 9.5% DEET formulation is that it appeared to retain a substantial degree of efficacy at six hours post-application, whereas the preferred formulation experienced a notable degradation in efficacy at that time interval. Nevertheless, when comparing the formulations over a four hour period, the preferred formulation is demonstrated to be efficacious and as good as the DEET-based formulation.

### EXAMPLE 5

A commercial insect repellent (Cutter's RTM) containing 6.7% DEET was tested in the same manner as the preferred formulation as described in Example 1. The result of the experiment was that the 6.7% DEET formulation experienced a total of 28 bites, for an average of 0.207 bites per time interval. These were spread over the five time intervals as follows: 0, 0, 3, 8, and 17 bites, for an average of 0.000, 0.000, 0.111, 0.296, and 0.630 bites per time interval.

In measuring the efficacy of the formulation as compared to the control, the overall efficacy was 93.52%. On a per time interval basis, the efficacy of the formulation was 100%, 100%, 95.38%, 90.45%, and 80.91%. The conclusion reached from the experiment is that the 6.7% DEET formulation slightly underperformed the preferred formulation at every time interval except at six hours post-application. The 6.7% DEET formulation is the recommended strength for use on children. Nevertheless, it still contains DEET, which has been shown to be harmful to children. The preferred formulation outperformed this DEET-based formulation, yet is all-natural and safe for children, and thus is a demonstrably superior product to the 6.7% DEET formulation.

The following tables summarize the findings from the experiments described in Examples 1-5:

TABLE 1
Number of Bites (27 Exposures per Time Interval)

| | Example 1 | Example 2 | Example 3 | Example 4 | Example 5 | |
|---|---|---|---|---|---|---|
| Time Interval | (Preferred) | (Alternative) | (Comparative) | (9.7% DEET) | (6.7% DEET) | Control |
| 0 | 1 | 1 | 3 | 0 | 0 | 104 |
| 1 | 0 | 4 | 0 | 0 | 0 | 92 |
| 2 | 2 | 5 | 0 | 0 | 3 | 64 |
| 4 | 5 | 21 | 9 | 8 | 8 | 84 |
| 6 | 29 | 36 | 11 | 7 | 17 | 88 |

TABLE 2
Efficacy as Percent of Control

| | Example 1 | Example 2 | Example 3 | Example 4 | Example 5 |
|---|---|---|---|---|---|
| Time Interval | (Preferred) | (Alternative) | (Comparative) | (9.7% DEET) | (6.7% DEET) |
| 0 | 99.05% | 99.05% | 97.15% | 100.00% | 100.00% |
| 1 | 100.00% | 95.65% | 100.00% | 100.00% | 100.00% |
| 2 | 96.92% | 92.29% | 100.00% | 100.00% | 95.38% |
| 4 | 94.03% | 74.90% | 89.26% | 90.45% | 90.45% |
| 6 | 67.45% | 59.62% | 87.67% | 92.15% | 80.91% |
| Overall efficacy: | 91.44% | 84.49% | 94.66% | 96.53% | 93.52% |

From the foregoing, it is shown that the preferred formulation outperformed the alternative, half-strength formulation at all time intervals, outperformed or equaled the comparative formulation in three of the five time intervals, outperformed or equaled the 9.5% DEET formulation in two of the five time intervals, and outperformed or equaled the 6.7% DEET formulation in three of the five time intervals. When considering only the first four hours, the preferred formulation's performance improved relative to all other formulations. This suggests that the invention is not only efficacious, but its efficacy is not dependent on chemical additives or synergists, and that it is a satisfactory alternative to, if not an improvement over, harmful DEET-based repellents.

Having fully described this invention, it will be appreciated by those skilled in the art that the same can be performed within a range of equivalent concentrations and conditions without departing from the spirit and scope of the invention. While this invention has been described in connection with specific embodiments thereof, it will be understood that it is capable of further modifications. This application is intended to cover any variations, uses, or adaptations of the invention following, in general, the principles of the invention and including such departures from the present disclosure as come within known or customary practice within the art to which the invention pertains and as may be applied to the essential features set forth herein as follows within the scope of the claims.

1. An insect repellent composition comprising a blend of one or more active ingredients comprised of organic agents and one or more inactive ingredients comprised of organic agents.

2. The insect repellent composition of claim 1 wherein the one or more active ingredients are essential oils.

3. The insect repellent composition of claim 2 wherein the active ingredients are five essential oils.

4. The insect repellent composition of claim 3 wherein the essential oils are lemongrass oil, peppermint oil, thyme oil, geranium oil, and rosemary oil.

5. The insect repellent composition of claim 1 wherein the inactive ingredient is comprised of one or more of the following: soybean oil and wheat germ oil.

6. The insect repellent composition of claim 4 wherein the inactive ingredient is comprised of one or more of the following: soybean oil and wheat germ oil.

7. The insect repellent composition of claim 4 wherein the inactive ingredients are soybean oil and wheat germ oil.

8. The insect repellent composition of claim 6 wherein the active ingredients in the aggregate comprise between 5% and 20% of the blend by weight.

9. The insect repellent composition of claim 6 wherein the active ingredients in the aggregate comprise 10% of the blend by weight.

10. The insect repellent composition of claim 7 wherein the active ingredients in the aggregate comprise between 5% and 20% of the blend by weight.

11. The insect repellent composition of claim 7 wherein the active ingredients in the aggregate comprise 10% of the blend by weight.

12. The insect repellent composition of claim 8 comprising:
a. between 1½% and 6% by weight lemongrass oil;
b. between 1% and 4% by weight peppermint oil;
c. between 1% and 4% by weight thyme oil;
d. between ¾% and 3% by weight geranium oil;
e. between ¾% and 3% by weight rosemary oil;
f. between 60% and 95% by weight soybean oil; and
g. between 0% and 20% by weight wheat germ oil.

13. The insect repellent composition of claim 10 comprising:
a. between 1½% and 6% by weight lemongrass oil;
b. between 1% and 4% by weight peppermint oil;
c. between 1% and 4% by weight thyme oil;
d. between ¾% and 3% by weight geranium oil;
e. between ¾% and 3% by weight rosemary oil;
f. between 60% and 94% by weight soybean oil; and
g. between 1% and 20% by weight wheat germ oil.

14. The insect repellent composition of claim 9 comprising:
a. 3% by weight lemongrass oil;
b. 2% by weight peppermint oil;
c. 2% by weight thyme oil;
d. 1½% by weight geranium oil;
e. 1½% by weight rosemary oil;
f. between 70% and 90% by weight soybean oil; and
g. between 0% and 20% by weight wheat germ oil.

15. The insect repellent composition of claim 11 comprising:
a. 3% by weight lemongrass oil;
b. 2% by weight peppermint oil;
c. 2% by weight thyme oil;
d. 1½% by weight geranium oil;
e. 1½% by weight rosemary oil;
f. 80% by weight soybean oil; and
g. 10% by weight wheat germ oil.
